(19) United States
(12) Patent Application Publication
(10) Pub. No.: US 2010/0304601 A1
(43) Pub. Date: Dec. 2, 2010

(54) ELECTRICAL CONNECTOR AND TERMINAL-CONNECTING ELEMENT THEREOF

(75) Inventor: Sheng-Ming Hsieh, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/701,590

(22) Filed: Feb. 7, 2010

Related U.S. Application Data
(60) Provisional application No. 61/180,931, filed on May 26, 2009.

(51) Int. Cl. H01R 4/24; H01R 24/00

(52) U.S. Cl. 439/405; 439/626

(57) ABSTRACT

An electrical connector includes an insulation body, a plurality of insulation wires, and a plurality of terminal-connecting elements. The insulation body has a plurality of receiving slots and a plurality of terminal-inserting openings. The terminal-connecting elements are disposed respectively in the receiving slots. Each of the terminal-connecting elements has a first protrusion and a second protrusion respectively fixing one of the insulation wires. An asymmetric single rib of each of the terminal-connecting elements protrudes toward a direction of one of the terminal-inserting openings. The asymmetric single rib has a projecting point electrically contacted with a corresponding terminal.

### CROSS-REFERENCE TO RELATED APPLICATION

This application claims the priority benefit of U.S. provisional application Ser. No. 61/180,931, filed on May 26, 2009. The entirety of the above-mentioned patent application is hereby incorporated by reference herein and made a part of specification.

### BACKGROUND OF INVENTION

1. Field of Invention

The invention relates to an electrical connector. More particularly, the invention relates to an electrical connector reducing contact resistance and a terminal-connecting element of the electrical connector.

2. Description of Related Art

Since in information era, transmitting data through networks has become increasingly popular, how to increase the speed of data transmission while ensuring transmission quality has become the key concern. The quality of transmission cables and electrical connectors, in particular, directly contributes to the quality of transmission, and are especially crucial when the bandwidth is high and the large amount of data is present. Therefore, to ensure the quality of various transmission cables and electrical connectors, classification and standards are established. The CAT 6 standard has specified the range of signal transmission from 1 GHz to X GHz. Hence, the routing of transmission cables and the structure of electrical connectors must be correspondingly improved in order to meet future requirements for transmitting signals with high frequencies.

Mechanical, structural design of the conventional electrical connector draws manufacturers' attention, while the high frequency connector must be developed to guarantee not only the mechanical, structural design but also electric properties of the electrical connector itself. Accordingly, development of the high frequency connector integrates with mechanical, structural design, analysis of mechanics, and analysis and measurement of high frequency electric properties.

In terms of analysis of high frequency electric properties, the electric properties of basic electronic elements (e.g. resistors, capacitors, inductors, and so on) must be understood, and basic theories (e.g. impedance matching, crosstalk generation and prevention, electromagnetic interference prevention, and so forth) must be followed. Besides, high frequency analysis software is applied to conduct simulation of high frequency electric properties of the electrical connector.

In U.S. Pat. No. 7,011,543, an electrical connector is disclosed. Two symmetric resilient nipping pieces are adopted in the electrical connector to resiliently hold a contact portion of a terminal for transmitting electrical signals on wires. However, since the resilient nipping portions and the terminal are contacted in a plane-to-plane manner, a contact area between the resilient nipping portions and the terminal is rather large. Thereby, contact resistance is unlikely to be reduced, and significant signal loss may occur when signals pass between the resilient nipping portions and the terminal, which may cause signal attenuation.

### SUMMARY OF INVENTION

The invention is directed to an electrical connector and a terminal-connecting element thereof for reducing contact resistance.

In the invention, an electrical connector including an insulation body, a plurality of insulation wires, and a plurality of terminal-connecting elements is provided. The insulation body has a plurality of receiving slots, and a plurality of terminal-inserting openings are formed at the receiving slots. The terminal-inserting openings are disposed relative to an inserting direction of a plurality of terminals. An end of each of the insulation wires extends to one of the receiving slots. The terminal-connecting elements are respectively disposed in the receiving slots. Each of the terminal-connecting elements has a first protrusion and a second protrusion respectively fixing one of the insulation wires. An asymmetric single rib of each of the terminal-connecting elements protrudes toward a direction of one of the terminal-inserting openings, and the asymmetric single rib has a projecting point electrically contacted with one of the terminals corresponding to the projecting point.

According to an embodiment of the invention, the insulation body further has a plurality of nipping portions that have a plurality of locking slots arranged in parallel. The locking slots connect the receiving slots. The end of each of the insulation wires passes through one of the locking slots and extends to one of the receiving slots.

According to an embodiment of the invention, the first protrusion has a first groove, the second protrusion has a second groove, and each of the insulation wires is held in the first groove and the second groove.

In the invention, a terminal-connecting element for an electrical connector having at least a receiving slot and at least a terminal-inserting opening is also provided. The terminal-connecting element includes a plurality of protrusions and an asymmetric single rib. The protrusions are located in the receiving slot. Each of the protrusions respectively has a groove for holding an insulation wire in the receiving slot. The asymmetric single rib connects the protrusions and protrudes toward a direction of the terminal-inserting opening. Besides, the asymmetric single rib has a projecting point electrically contacted with a corresponding terminal.

According to an embodiment of the invention, an end of the asymmetric single rib has a resilient bending portion on which the projecting point is located.

According to an embodiment of the invention, the projecting point is a hemisphere, the corresponding terminal has a contact plane, and the hemisphere and the contact plane are contacted in a point-to-plane manner.

Based on the above, in the electrical connector and its terminal-connecting element of the invention, the projecting point on the asymmetric single rib is used to electrically connect the corresponding terminal. Since the terminal is not held by the conventional resilient nipping portions, a contact area between the projecting point and the terminal is reduced, and a contact stress is increased. Thereby, signals with high frequencies can smoothly pass between the asymmetric single rib and the terminal, thus reducing contact resistance resulting from signal transmission.

It is to be understood that both the foregoing general descriptions and the detailed embodiments are exemplary and are, together with the accompanying drawings, intended to provide further explanation of technical features and advantages of the invention.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional view illustrating an electrical connector according to an embodiment of the invention.

FIG. 2 is a schematic view illustrating a structure of a terminal-connecting element depicted in FIG. 1.

### DESCRIPTION OF EMBODIMENTS

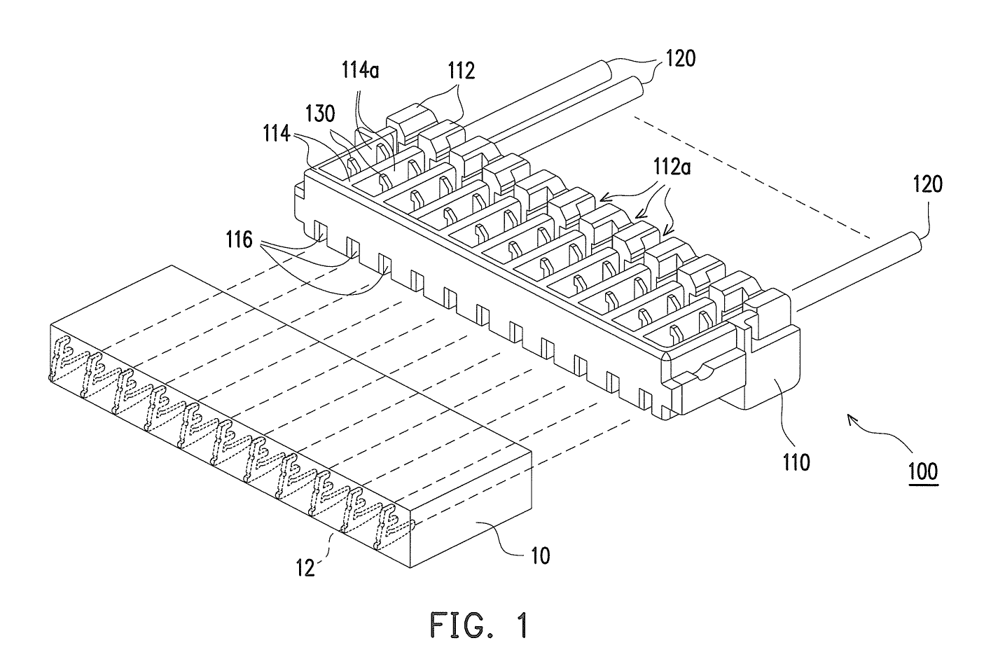

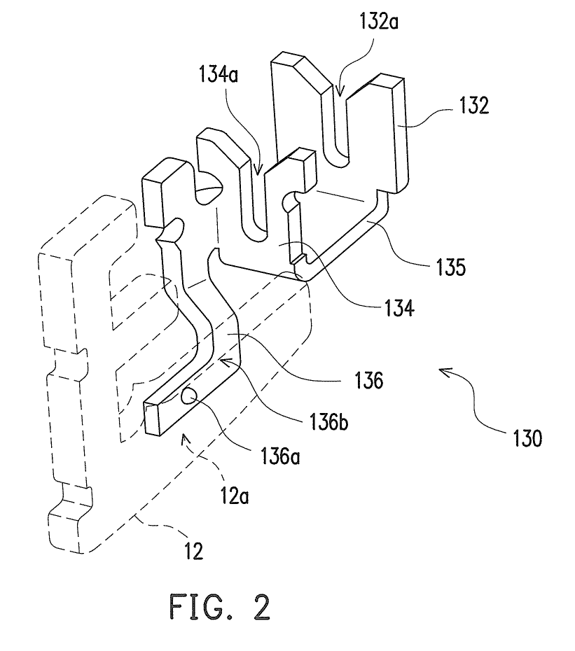

FIG. 1 is a schematic three-dimensional view illustrating an electrical connector according to an embodiment of the invention. FIG. 2 is a schematic view illustrating a structure of a terminal-connecting element depicted in FIG. 1.

In FIG. 1, an electrical connector 100 includes an insulation body 110, a plurality of insulation wires 120, and a plurality of terminal-connecting elements 130. The insulation body 110 has a plurality of nipping portions 112 and a plurality of fixing portions 114. A plurality of locking slots 112a arranged in parallel are disposed between the nipping portions 112, and the fixing portions 114 have a plurality of receiving slots 114a connecting the locking slots 112a. Besides, a plurality of terminal-inserting openings 116 are formed at the receiving slots 114a. The terminal-inserting openings 116 are disposed relative to an inserting direction of a plurality of terminals 12. In this embodiment, the electrical connector 100 is, for example, a male plug which can be inserted in another electrical connector 10 (a female socket) soldered to a circuit board (not shown), such that the two connectors 100 and 10 are electrically connected.

In addition, the insulation wires 120 are located at one side of the insulation body 110 and arranged in parallel in a length direction of the insulation body 110. An end of each of the insulation wires 120 respectively passes through one of the locking slots 112a and extends to one of the receiving slots 114a. Besides, the terminal-connecting elements 130 are respectively disposed in the receiving slots 114a, and each of the terminal-connecting elements 130 has a first protrusion 132 and a second protrusion 134 respectively fixing one of the insulation wires 120. In FIG. 2, the first protrusion 132 has a first groove 132a, and the second protrusion 134 has a second groove 134a. Bottoms of the first and the second protrusions 132 and 134 are integrally connected by a base board 135. Hence, each of the insulation wires 120 can be held in the first groove 132a and the second groove 134a, and core lines (not shown) in the insulation wires 120 are electrically connected to the terminal-connecting elements 130.

An asymmetric single rib 136 of each of the terminal-connecting elements 130 protrudes toward a direction of one of the terminal-inserting openings 116, and the asymmetric single rib 136 has a projecting point 136a electrically contacted with one of the terminals 12 corresponding to the projecting point 136a. As shown in FIG. 2, the asymmetric single rib 136 is connected to a side wall of the second protrusion 134. An extending direction of the asymmetric single rib 136 is opposite to a protruding direction of the second protrusion 134. In fact, the asymmetric single rib 136 extends in a downward manner. An end of the asymmetric single rib 136 has a resilient bending portion 136b which inclines toward the downside of the base board 135, rotates by 90 degrees, and then extends toward the terminal-inserting openings 116. The projecting point 136a is electrically contacted to the corresponding terminal 12 in a point-to-plane manner rather than in a plane-to-plane manner. Accordingly, the contact area between the projecting point 136a and the corresponding terminal 12 is reduced, and the contact stress is increased, which complies with the Hertzian contact solution.

In this embodiment, a resilient force of the resilient bending portion 136b gives rise to an increase in a normal force applied to the corresponding terminal 12 by the asymmetric single rib 136. Additionally, when the projecting point 136a and the corresponding terminal 12 are electrically contacted in a point-to-plane manner, the contact area between the projecting point 136a and the corresponding terminal 12 can be reduced by 58% or more. Therefore, contact resistance which results from transmission of signals with high frequencies can be reduced significantly, and signal transmission can be more easily performed.

When a normal contact force is applied to two mating resilient objects, an amount of deformation and stresses that develop as the two objects come in contact can be calculated by conducting the Hertzian contact solution. Here, the two mating objects can be two spheres, one sphere and one plane, two cylinders, one cylinder and one plane, and so on, for example. As a result, when the projecting point 136a is a hemisphere, and the corresponding terminal 12 has a contact plane 12a, it can be concluded that the smaller the circular contact area between the hemisphere and the plane, the more the contact stress. In the electrical connector for transmitting signals with high frequencies, when the signals pass through the asymmetric single rib 136 and the corresponding terminal 12, the contact resistance is extremely small (less than 3 mΩ), so as to prevent significant signal loss or signal attenuation during transmission.

In light of the foregoing, the projecting point on the asymmetric single rib is adopted in the electrical connector and its terminal-connecting element of the invention to electrically connect the corresponding terminal. Since the terminal is not held by the conventional resilient nipping portions, the contact area between the projecting point and the corresponding terminal is reduced, and the contact stress is increased. Thereby, signals with high frequencies can smoothly pass between the asymmetric single rib and the terminal, thus reducing contact resistance resulting from signal transmission.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electrical connector for electrically connecting a plurality of terminals, the electrical connector comprising:
an insulation body having a plurality of receiving slots, a plurality of terminal-inserting openings being formed at the receiving slots, the terminal-inserting openings being disposed relative to an inserting direction of the terminals;
a plurality of insulation wires, an end of each of the insulation wires extending to one of the receiving slots; and
a plurality of terminal-connecting elements respectively disposed in the receiving slots, each of the terminal-connecting elements having a first protrusion and a second protrusion respectively fixing one of the insulation wires, wherein an asymmetric single rib of each of the terminal-connecting elements protrudes toward a direction of one of the terminal-inserting openings, and the asymmetric single rib has a projecting point electrically contacted with one of the terminals corresponding to the projecting point.

2. The electrical connector as claimed in claim 1, wherein the insulation body further has a plurality of nipping portions having a plurality of locking slots arranged in parallel, the locking slots connect the receiving slots, and the end of the each of the insulation wires passes through one of the locking slots and extends to the one of the receiving slots.

3. The electrical connector as claimed in claim 1, wherein the first protrusion has a first groove, the second protrusion has a second groove, and each of the insulation wires is held in the first groove and the second groove.

4. The electrical connector as claimed in claim 1, wherein an end of the asymmetric single rib has a resilient bending portion, and the projecting point is located on the resilient bending portion.

5. The electrical connector as claimed in claim 1, wherein the projecting point is a hemisphere, the one of the terminals corresponding to the projecting point has a contact plane, and the hemisphere and the contact plane are contacted in a point-to-plane manner.

6. A terminal-connecting element for an electrical connector having at least a receiving slot and at least a terminal-inserting opening, the terminal-connecting element comprising:
a plurality of protrusions located in the at least a receiving slot, each of the protrusions respectively having a groove for holding an insulation wire in the at least a receiving slot; and
an asymmetric single rib connecting the protrusions and protruding toward a direction of the at least a terminal-inserting opening, the asymmetric single rib having a projecting point electrically contacted with a corresponding terminal.

7. The terminal-connecting element as claimed in claim 6, wherein an end of the asymmetric single rib has a resilient bending portion, and the projecting point is located on the resilient bending portion.

8. The terminal-connecting element as claimed in claim 6, wherein the projecting point is a hemisphere, the corresponding terminal has a contact plane, and the hemisphere and the contact plane are contacted in a point-to-plane manner.
